(19) United States
(12) Patent Application Publication
(10) Pub. No.: US 2024/0302687 A1
(43) Pub. Date: Sep. 12, 2024

(54) DISPLAY MODULE AND MANUFACTURING METHOD THEREOF, AND DISPLAY DEVICE

(71) Applicants: BEIJING BOE DISPLAY TECHNOLOGY CO., LTD., Beijing (CN); BOE TECHNOLOGY GROUP CO., LTD., Beijing (CN)

(72) Inventors: Changjia FU, Beijing (CN); Zhuang XU, Beijing (CN); Haijun SHI, Beijing (CN); Bochang WANG, Beijing (CN); Wei ZHONG, Beijing (CN); Hongbo FENG, Beijing (CN)

(21) Appl. No.: 18/005,107

(22) PCT Filed: Oct. 29, 2021
(86) PCT No.: PCT/CN2021/127516

§ 371 Date: Jan. 11, 2023

(51) Int. Cl. G02F 1/1333; G02F 1/1335; G02F 1/13357

(52) U.S. Cl. CPC G02F 1/133317; G02F 1/133512; G02F 1/133528; G02F 1/133611; G02F 1/13336; G02F 2202/28

(57) ABSTRACT

The embodiments of the present disclosure provide a display module, a manufacturing method thereof, and a display device. The display module includes a liquid crystal cell, a first polarizer, a functional layer, a middle frame, the first polarizer is on a main surface of the liquid crystal cell, the functional layer is integrated in the first polarizer or the functional layer is provided on a side of the first polarizer away from the liquid crystal cell. The functional layer is configured to increase a brightness of the display module and adjust a haze of the display module, the liquid crystal cell, the first polarizer and the functional layer are combined to form a display panel. The middle frame is on a side of the functional layer away from the liquid crystal cell, a side edge of the functional layer is provided outside a display region of the display panel.

### TECHNICAL FIELD

Embodiments of the present disclosure relate to a display module, a manufacturing method of the display module, and a display device.

### BACKGROUND

The application of the display device formed by a splicing screen is becoming more and more widespread, the display device including the splicing screen is usually formed by splicing a plurality of independent display modules, and each of the display modules includes a display panel and a backlight module. The display device including the splicing screen usually includes a plurality of seams, and each of the seams is formed by the edges of two backlight modules of two adjacent display modules, that is, the width of the seam is equal to a sum of the widths of the edges of the two backlight modules, and the width of the seam of the display device including the splicing screen is usually greater than 3 mm. Because the width of the seam of the display device including the splicing screen is generally large, the display effect of the current display device including the splicing screen is also generally poor.

At present, in a backlight structure, a diffuser plate and each optical film are assembled with a plastic frame by snaps or glue, an inner side wall of the plastic frame will form bright lines due to reflection, and the tape part of the diffuser plate and the plastic frame will form a dark band. In the design of the narrow bezel, bright and dark edges will be formed at the edges of the screen due to the difference of brightness, especially in products such as splicing screens or ultra-narrow bezels, which will seriously affect the quality of the display device including the splicing screen.

### SUMMARY

At least one embodiment of the present disclosure provides a display module, a manufacturing method of the display module, and a display device, and the display module integrates the functional layer in the first polarizer or the functional layer is arranged on the side of the first polarizer away from the liquid crystal cell, and the side edge of the functional layer is arranged outside the display region of the display panel, so as to improve the brightness of the display module and adjust the haze of the display module, and the assembly process of the display module is simplified, so that the display module becomes lighter and thinner, which saves material costs.

At least one embodiment of the present disclosure provides a display module, and the display module includes: a display panel, comprising a liquid crystal cell, a first polarizer, and a functional layer, in which the first polarizer is provided on a main surface of the liquid crystal cell, and the functional layer is at least configured to increase a brightness of the display module and adjust a haze of the display module; and a middle frame, provided on a side of the functional layer away from the liquid crystal cell, in which the functional layer is integrated in the first polarizer or provided on a side of the first polarizer away from the liquid crystal cell, and a side edge of the functional layer is provided outside a display region of the display panel.

For example, in the display module provided by at least one embodiment of the present disclosure, the functional layer comprises a first brightness enhancement layer and a first haze adjustment layer which are stacked, the first brightness enhancement layer is configured to increase the brightness of the display module, and the first haze adjustment layer is configured to adjust the haze of the display module.

For example, in the display module provided by at least one embodiment of the present disclosure, both of a side edge of the first brightness enhancement layer and a side edge of the first haze adjustment layer are provided outside the display region of the display panel.

For example, in the display module provided by at least one embodiment of the present disclosure, the first brightness enhancement layer is provided on a side of the first haze adjustment layer close to the liquid crystal cell.

For example, in the display module provided by at least one embodiment of the present disclosure, a haze of the first haze adjustment layer is from 70% to 90%.

For example, in the display module provided by at least one embodiment of the present disclosure, a material of the first haze adjustment layer comprises polyethylene terephthalate, a surface of the first haze adjustment layer comprises diffusion particles, and a particle size of each of the diffusion particles is from 1 μm to 25 μm.

For example, in the display module provided by at least one embodiment of the present disclosure, in a direction from the first polarizer to the liquid crystal cell, the first brightness enhancement layer comprises a brightness enhancement film, a diffusion film, and a prism layer that are stacked sequentially.

For example, in the display module provided by at least one embodiment of the present disclosure, the first brightness enhancement layer and the first haze adjustment layer are integrated in the first polarizer, and in a direction from the first polarizer to the liquid crystal cell, the first polarizer comprises the first haze adjustment layer, the first brightness enhancement layer, a first pressure-sensitive adhesive, a first protective layer, a first polarization functional layer, a second protective layer, and a second pressure-sensitive adhesive that are stacked sequentially.

For example, the display module provided by at least one embodiment of the present disclosure further comprises a second polarizer provided on a side of the liquid crystal cell away from the first polarizer, and in the direction from the first polarizer to the liquid crystal cell, the second polarizer comprises a third pressure-sensitive adhesive, a third protective layer, a second polarization functional layer, a fourth protective layer, a second haze adjustment layer, and a protective film that are stacked sequentially.

For example, in the display module provided by at least one embodiment of the present disclosure, a haze of the second haze adjustment layer is from 50% to 90%.

For example, in the display module provided by at least one embodiment of the present disclosure, the haze of the second haze adjustment layer is smaller than a haze of the first haze adjustment layer.

For example, in the display module provided by at least one embodiment of the present disclosure, the first brightness enhancement layer and the first haze adjustment layer are stacked and provided on the side of the first polarizer away from the liquid crystal cell.

For example, in the display module provided by at least one embodiment of the present disclosure, the first brightness enhancement layer is fully bonded to the first polarizer by a first bonding adhesive, and the first haze adjustment layer is fully bonded to the first brightness enhancement layer by a second bonding adhesive.

For example, the display module provided by at least one embodiment of the present disclosure further comprises a second polarizer provided on a side of the display panel away from the first polarizer, in which a haze of the second polarizer is 5%, a haze of the first polarizer is 0, and a haze of the first bonding adhesive is from 60% to 90%.

For example, in the display module provided by at least one embodiment of the present disclosure, both the first bonding adhesive and the second bonding adhesive comprise a hot melt adhesive or a UV-curable adhesive.

For example, in the display module provided by at least one embodiment of the present disclosure, a distance between the side edge of the functional layer and an edge of a side, which is the same side as the side edge of the functional layer, of the display region of the display panel is from 0.1 mm to 0.3 mm.

For example, in the display module provided by at least one embodiment of the present disclosure, a light-shielding tape is provided on a side surface of the display panel.

For example, in the display module provided by at least one embodiment of the present disclosure, the display panel and the middle frame are connected with each other by a third bonding adhesive.

At least one embodiment of the present disclosure further provides a manufacturing method of a display module, and the manufacturing method comprises: providing a liquid crystal cell and a middle frame; forming a first polarizer on a main surface of the liquid crystal cell, in which the middle frame is located on a side of the first polarizer away from the liquid crystal cell; and integrating a functional layer in the first polarizer or forming the functional layer on a side of the first polarizer away from the liquid crystal cell, in which the functional layer is at least configured to increase a brightness of the display module and adjust a haze of the display module, the liquid crystal cell, the first polarizer, and the functional layer are combined to form a display panel, and a side edge of the functional layer is provided outside a display region of the display panel.

For example, in the manufacturing method provided by at least one embodiment of the present disclosure, the functional layer comprises a first brightness enhancement layer and a first haze adjustment layer which are stacked, and the forming the functional layer on the side of the first polarizer away from the liquid crystal cell comprises: fully bonding the first brightness enhancement layer on the first polarizer by using a first bonding adhesive, and fully bonding the first haze adjustment layer on the first brightness enhancement layer by using a second bonding adhesive.

For example, in the manufacturing method provided by at least one embodiment of the present disclosure, the functional layer comprises a first brightness enhancement layer and a first haze adjustment layer which stacked, and the integrating the functional layer in the first polarizer comprises: sequentially integrating the first brightness enhancement layer and the first haze adjustment layer in the first polarizer.

For example, in the manufacturing method provided by at least one embodiment of the present disclosure, the display panel and the middle frame are connected with each other by a third bonding adhesive.

At least one embodiment of the present disclosure further provides a display device, and the display device comprises a splicing screen formed by splicing a plurality of display modules according to any one of the embodiments mentioned above.

### BRIEF DESCRIPTION OF THE DRAWINGS

In order to clearly illustrate the technical solution of the embodiments of the present disclosure, the drawings of the embodiments will be briefly described. It is obvious that the described drawings in the following are only related to some embodiments of the present disclosure and thus are not limitative of the present disclosure.

FIG. 1 is a schematic diagram of a cross-sectional structure of a display module:

FIG. 2A is a schematic diagram of a cross-sectional structure of a display module provided by at least one embodiment of the present disclosure:

FIG. 2B is a schematic diagram of a three-dimensional structure of a display module provided by at least one embodiment of the present disclosure:

FIG. 3 is a schematic diagram of a cross-sectional structure of a functional layer provided by at least one embodiment of the present disclosure;

FIG. 4 is a schematic diagram of a cross-sectional structure of a display panel provided by at least one embodiment of the present disclosure;

FIG. 5 is a schematic diagram of a cross-sectional structure of a liquid crystal cell provided by at least one embodiment of the present disclosure:

FIG. 6A is a schematic diagram of a cross-sectional structure of another display module provided by at least one embodiment of the present disclosure:

FIG. 6B is a schematic diagram of a three-dimensional structure of another display module provided by at least one embodiment of the present disclosure:

FIG. 7 is a schematic diagram of a cross-sectional structure of providing a functional layer on a side of a first polarizer away from a liquid crystal cell provided by at least one embodiment of the present disclosure:

FIG. 8 is an optical path diagram of a display module provided by at least one embodiment of the present disclosure:

FIG. 9 is a flowchart of a manufacturing method of a display module provided by at least one embodiment of the present disclosure;

FIG. 10 is a flowchart of another manufacturing method of a display module provided by at least one embodiment of the present disclosure; and

FIG. 11 is a schematic diagram of a plane structure of a display device provided by at least one embodiment of the present disclosure.

### DETAILED DESCRIPTION

In order to make objects, technical details and advantages of the embodiments of the present disclosure apparent, the technical solutions of the embodiments will be described in a clearly and fully understandable way in connection with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” and similar terms are not intended to indicate any sequence, amount or importance, but distinguish various components. The terms “comprise,” “comprising,” “include,” “including,” etc., are intended to specify that the elements or the objects stated before these terms encompass the elements or the objects and equivalents thereof listed after these terms, but do not preclude the other elements or objects. The terms “connect”, “connected”, etc., are not intended to define a physical connection or mechanical connection, but may include an electrical connection, directly or indirectly. “On,” “under,” “left,” “right” and the like are only used to indicate relative position relationship, and when the absolute position of the object which is described is changed, the relative position relationship may be changed accordingly.

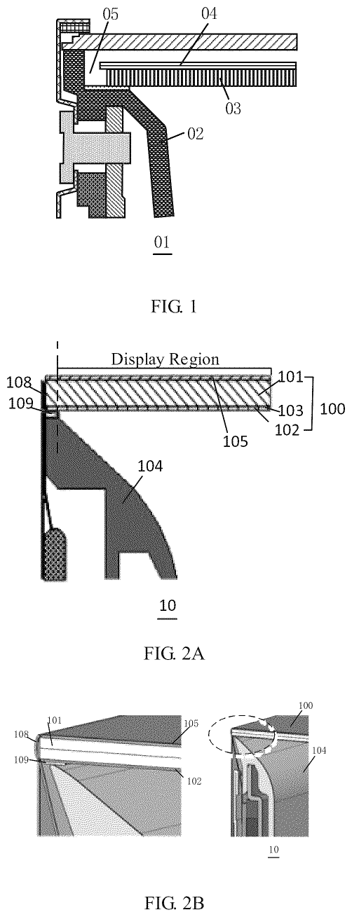

FIG. 1 is a schematic diagram of a cross-sectional structure of a display module. As shown in FIG. 1, the display module 01 includes a diffuser plate 03 provided on a support surface of a middle frame 02, and an optical film layer 04 provided on the diffuser plate 03. Because the diffuser plate 03 and the optical film layer 04 will be thermally expanded when the light source is irradiated, an expansion space 05 needs to be reserved between the diffuser plate 03 and the middle frame 02, and between the optical film layer 04 and the middle frame 02, so that the diffuser plate 03 and the optical film layer 04 can shrink or expand. However, due to the blocking of the middle frame 02, very little light comes into the expansion space 05. Therefore, the problem of dark frames appearing at the edges of the display region of the display module 01 may occur. In addition, because the light will gather to the edge of the optical film layer 04, the problem of bright edges appearing at the edges of the display region of the display module 01 may occur.

The inventors of the present disclosure propose an ultra-simplified module structure design solution based on a full-lamination structure of film materials, and the design solution is especially suitable for optimizing the image quality of ultra-narrow bezel splicing screens, simplifying the manufacturing process and reducing the production cost. That is, by integrating a brightness enhancement layer and a high haze surface treatment layer in a lower polarizer of a liquid crystal display (LCD) screen, or by adopting a structure in which the optical film layer and the LCD screen are fully bonded by an optical adhesive to replace the traditional structure of the backlight source diffuser plate and the optical film layer, the process of assembling the display module is simplified, so that the formed display module is lighter and thinner, and the material cost is saved. After the above solution is adopted, because the edge of the lower polarizer or the optical film layer is outside the display region, the problem of the bright edges appearing at the surrounding films of the display module can be reduced or eliminated, and after the separately provided diffuser plate is removed, the problem of dark frames appearing at the edges of the display module, which is caused by the expansion space reserved between the diffuser plate and the middle frame, can be reduced or eliminated, which can improve the picture quality and market competitiveness of the product.

At least one embodiment of the present disclosure provides a display module, and the display module includes a liquid crystal cell, a first polarizer, a functional layer, and a middle frame. The first polarizer is provided on a main surface of the liquid crystal cell, and the functional layer is integrated in the first polarizer or provided on a side of the first polarizer away from the liquid crystal cell. The functional layer is at least configured to increase a brightness of the display module and adjust a haze of the display module, and the liquid crystal cell, the first polarizer and the functional layer are combined to form a display panel. The middle frame is provided on a side of the functional layer away from the liquid crystal cell, and a side edge of the functional layer is provided outside a display region of the display panel.

For example, FIG. 2A is a schematic diagram of a cross-sectional structure of a display module provided by at least one embodiment of the present disclosure. As shown in FIG. 2A, the display module 10 includes a display panel 100 and a middle frame 104, and the display panel 100 includes a liquid crystal cell 101, a first polarizer 102, and a functional layer 103. The first polarizer 102 is provided on a main surface of the liquid crystal cell 101, the functional layer 103 is integrated in the first polarizer 102, and the functional layer 103 is at least configured to increase the brightness of the display module 10 and adjust the haze of the display module 10. The liquid crystal cell 101, the first polarizer 102 and the functional layer 103 are stacked and combined to form the display panel 100, the middle frame 104 is provided on a side of the functional layer 103 away from the liquid crystal cell 101, and a side edge of the functional layer 103 is provided outside a display region of the display panel 100. The display module 10 can reduce or eliminate the problem of bright edges of the surrounding film material, and after removing a separately provided diffuser plate, can further reduce or eliminate the problem of dark frames at the edges of the display module caused by the expansion space reserved between the diffuser plate and the middle frame, thereby improving the picture quality and market competitiveness of the product.

It should be noted that, the liquid crystal cell 101 has two main surfaces, one of the main surfaces is a display surface, the other one of the main surfaces is a surface opposite to the display surface, and the first polarizer 102 is provided on the main surface of the liquid crystal cell 101 opposite to the display surface.

For example, FIG. 2A shows the range of the display region, the right side of the dotted line in FIG. 2A is the part of the display region, and the position from the leftmost side of the display panel to the dotted line is the non-display region of the display panel. In one example, the width from the leftmost side of the display panel to the position of the dotted line is from 0.1 mm to 0.3 mm. That is, the non-display region of the display panel is within the range of 0.1 mm to 0.3 mm from the side of the display panel to the inside, and the remaining part is the display region.

For example, FIG. 2B is a schematic diagram of a three-dimensional structure of a display module provided by at least one embodiment of the present disclosure. The figure on the left in FIG. 2B is a schematic diagram of an enlarged structural of the elliptical dotted line region in the figure on the right in FIG. 2B, as shown in FIG. 2B, the relevant descriptions of the display module 10 can refer to the above-mentioned relevant descriptions of FIG. 2A, which is not repeated herein.

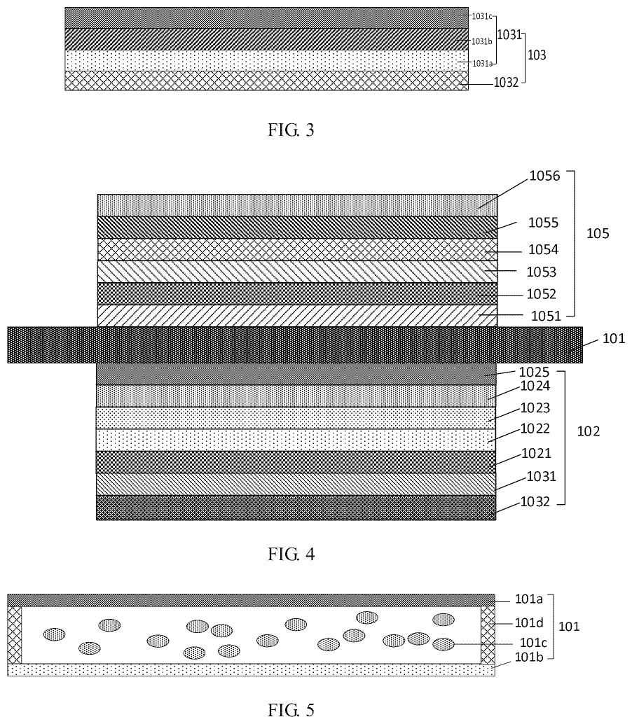

For example, FIG. 3 is a schematic diagram of a cross-sectional structure of a functional layer provided by at least one embodiment of the present disclosure. As shown in FIG. 3, the functional layer 103 includes a first brightness enhancement layer 1031 and a first haze adjustment layer 1032 which are stacked, the first brightness enhancement layer 1031 is configured to increase the brightness of the display module 10, and the first haze adjustment layer 1032 is configured to adjust the haze of the display module 10. The overall structure of the functional layer 103 can reduce or eliminate the problem of the bright edges of the surrounding films, and there is no expansion space after removing the separately provided diffuser plate, so the problem of the dark frames at the edges of the display module can be reduced or eliminated.

For example, the function of the first haze adjustment layer 1032 is to block light to improve the overall haze of the first polarizer 102.

It should be noted that the haze is a percentage of the transmitted light intensity that deviates from the incident light at an angle of more than 2.5° to the total transmitted light intensity. The greater the haze, the lower the gloss and transparency of the film, especially the lower the imaging degree. The haze may also mean that, in the case where a beam of parallel light from a standard “c” light source is vertically irradiated on a transparent or semi-transparent film, sheet or plate, and due to scattering in the interior and surface of the material, the percentage of the ratio of the scattered luminous flux Td, which causes part of the parallel light to deviate from the incident direction by more than 2.5°, to the luminous flux T2 transmitted through the material.

For example, in one example, the first brightness enhancement layer 1031 is provided on a side of the first haze adjustment layer 1032 close to the liquid crystal cell 101.

For example, referring to FIG. 2A and FIG. 3, the side edges of both the first brightness enhancement layer 1031 and the first haze adjustment layer 1032 are provided outside the display region of the display panel 100, that is, the side edges of the first brightness enhancement layer 1031 and the first haze adjustment layer 1032 are all provided to exceed the boundary of the display region of the display panel 100, so as to ensure that the brightness of the corresponding position of the display region can be increased.

For example, in one example, the haze of the first haze adjustment layer 1032 is from 70% to 90%. For example, the haze of the first haze adjustment layer 1032 is 70%, 75%, 80%, 85%, or 90%.

For example, in one example, the material of the first haze adjustment layer 1032 includes polyethylene terephthalate, the surface of the first haze adjustment layer 1032 includes diffusion particles, and the particle size of each of the diffusion particles is from 1 μm to 25 μm. For example, the material of the diffusion particles includes transparent particles such as silicon dioxide, titanium dioxide, and the like, and the particle size of each of the diffusion particles is 1 μm, 4 μm, 6 μm, 10 μm, 14 μm, 18 μm, 20 μm, 24 μm, or 25 μm.

For example, combining FIG. 2A with FIG. 3, in the direction from the first polarizer 102 to the liquid crystal cell 101, the first brightness enhancement layer 1031 includes a brightness enhancement film 1031a, a diffusion film 1031b, and a prism layer 1031c that are stacked sequentially. The brightness enhancement film 1031a can achieve the brightness enhancement, the diffusion film 1031b can achieve the diffusion of the light incident therein, and the prism layer 1031c can achieve the deflection of light.

For example, FIG. 4 is a schematic diagram of a cross-sectional structure of a display panel provided by at least one embodiment of the present disclosure, combining FIG. 2A with FIG. 4, the first brightness enhancement layer 1031 and the first haze adjustment layer 1032 are integrated in the first polarizer 102, and in the direction from the first polarizer 102 to the liquid crystal cell 101, the first polarizer 102 includes the first haze adjustment layer 1032, the first brightness enhancement layer 1031, a first pressure-sensitive adhesive 1021, a first protective layer 1022, a first polarization functional layer 1023, a second protective layer 1024, and a second pressure-sensitive adhesive 1025 that are stacked sequentially.

For example, the first haze adjustment layer 1032 is configured to increase the haze of the first polarizer 102. The first brightness enhancement layer 1031 is configured to increase the brightness of the display panel 100. The first pressure-sensitive adhesive 1021 is configured to connect the first brightness enhancement layer 1031 and the first protective layer 1022. The first polarization functional layer 1023 is sandwiched between the first protective layer 1022 and the second protective layer 1024, and the first protective layer 1022 and the second protective layer 1024 are configured to protect the first polarization functional layer 1023. The second pressure-sensitive adhesive 1025 is configured to connect the liquid crystal cell 101 and the first polarizer 102.

It should be noted that, the first haze adjustment layer 1032 and the first brightness enhancement layer 1031 are connected with each other by a bonding adhesive, and the thickness of the bonding adhesive is very thin, which is not shown in FIG. 4.

For example, as shown in FIG. 2A and FIG. 4, the display module 10 further includes a second polarizer 105 provided on the side of the liquid crystal cell 101 away from the first polarizer 102. For example, the second polarizer 105 is a multi-layer structure in which multiple layers are stacked, and in the direction from the first polarizer 102 to the liquid crystal cell 101, the second polarizer 105 includes a third pressure-sensitive adhesive 1051, a third protective layer 1052, a second polarization functional layer 1053, a fourth protective layer 1054, a second haze adjustment layer 1055, and a protective film 1056 that are stacked sequentially.

For example, as shown in FIG. 4, the third pressure-sensitive adhesive 1051 is configured to connect the second polarizer 105 and the liquid crystal cell 101. The second polarization functional layer 1053 is sandwiched between the third protective layer 1052 and the fourth protective layer 1054. The third protective layer 1052 and the fourth protective layer 1054 are configured to protect the second polarization functional layer 1053. The second haze adjustment layer 1055 is configured to adjust the haze of the second polarizer 105, and the protective film 1056 is configured to protect the second polarizer 105.

For example, in FIG. 4, the second polarization functional layer 1053 is a polyvinyl alcohol layer. The material of the first protective layer 1022, the material of the second protective layer 1024, the material of the third protective layer 1052 and the material of the fourth protective layer 1054 are all cellulose triacetate. The third pressure-sensitive adhesive 1051 includes a water-soluble pressure-sensitive adhesive, a solvent-based pressure-sensitive adhesive, an emulsion-type pressure-sensitive adhesive, a hot-melt pressure-sensitive adhesive, a calendering pressure-sensitive adhesive, or the like.

For example, in another embodiment, the second polarizer 105 is a wire grid polarizer.

For example, as shown in FIG. 4, the haze of the second haze adjustment layer 1055 is from 50% to 90%. For example, the haze of the second haze adjustment layer 1055 is 50%, 55%, 60%, 65%, 70%, 75%, 80%, 85% or 90%, which is not limited by the embodiments of the present disclosure.

For example, as shown in FIG. 4, the haze of the second haze adjustment layer 1055 is smaller than the haze of the first haze adjustment layer 1032, that is, the haze adjusting ability of the second haze adjustment layer 1055 is greater than the haze adjusting ability of the first haze adjustment layer 1032.

For example, FIG. 5 is a schematic diagram of a cross-sectional structure of a liquid crystal cell provided by at least one embodiment of the present disclosure. As shown in FIG. 5, the liquid crystal cell 101 includes a first substrate 101a and a second substrate 101b facing each other and spaced apart from each other, and a liquid crystal layer 101c between the first substrate 101a and the second substrate 101b. Although not shown, a plurality of gate lines and a plurality of data lines are formed on the inner surface of the first substrate 101a (for example, an array substrate). The plurality of gate lines and the plurality of data lines cross each other to define a plurality of pixel regions, and thin film transistors (TFTs) are connected to both the gate lines and the data lines. A transparent pixel electrode in each of the pixel regions is electrically connected with a source electrode or a drain electrode one of the thin film transistors. In addition, a black matrix covering the gate lines, the data lines, and the thin film transistors is formed on the inner surface of the second substrate 101b (for example, a color filter substrate), and a color filter layer including red color filters, green color filters and blue color filters is formed on the black matrix, for example, a transparent common electrode is formed on the color filter layer.

As shown in FIG. 5, a first alignment layer (not shown in FIG. 5) is formed between the first substrate 101a and the liquid crystal layer 101c, and a second alignment layer (not shown in FIG. 5) is formed between the second substrate 101b and the liquid crystal layer 101c. In addition, a sealing pattern 101d is formed in an edge portion between the first substrate 101a and the second substrate 101b. The sealing pattern 101d is, for example, a frame sealant pattern to prevent leakage of the liquid crystal layer. For example, the sealing pattern 101d is not limited to thermally curable frame sealant or UV-curable frame sealant. An accommodating space is formed between the sealing pattern 101d and the first substrate 101a as well as the second substrate 101b, and the liquid crystal layer 101c is provided in the accommodating space.

For example, the material of the first substrate 101a and the material of the second substrate 101b include glass, plastic or other light-transmitting materials, and the material of the first substrate 101a and the material of the second substrate 101b are the same or different.

It should be noted that, in the structure shown in FIG. 5, the liquid crystal display panel is formed by using the liquid crystal layer 101c as a display medium. In the embodiments of the present disclosure, the display medium may also be an organic electroluminescent material or an electrophoretic material, which is not limited in the embodiments of the present disclosure.

For example, as shown in FIG. 2, the middle frame 104 has an arc-shaped surface 104a and a first support surface 104b connected with the arc-shaped surface 104a, and the middle frame is connected with the first polarizer 102 at the first support surface 104b.

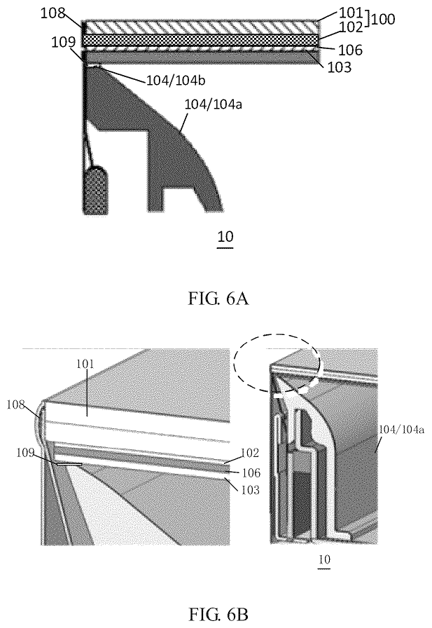

For example, FIG. 6A is a schematic diagram of a cross-sectional structure of another display module provided by at least one embodiment of the present disclosure. As shown in FIG. 6A, the display module 10 includes a liquid crystal cell 101, a first polarizer 102, a functional layer 103, and a middle frame 104. The first polarizer 102 is provided on the main surface of the liquid crystal cell 101, the functional layer 103 is provided on a side of the first polarizer 102 away from the liquid crystal cell 101, and the functional layer 103 is at least configured to increase the brightness of the display module 10 and adjust the haze of the display module 10. The liquid crystal cell 101, the first polarizer 102, and the functional layer 103 are combined to form a display panel 100, the middle frame 104 is provided on a side of the functional layer 103 away from the liquid crystal cell 101, and the side edge of the functional layer 103 is provided outside the display region of the display panel 100. For example, in FIG. 6A, a second bonding adhesive 106 is provided between the functional layer 103 and the first polarizer 102, and the second bonding adhesive 106 is configured to connect the first polarizer 102 and the functional layer 103.

For example, as shown in FIG. 6A, the middle frame 104 has an arc-shaped surface 104a and a first support surface 104b connected with the arc-shaped surface 104a, and the middle frame is connected with the functional layer 103 by using an optical adhesive at the first support surface 104b, so as to play a role of supporting the display panel 100. The width of the first support surface 104b is from 0.5 mm to 1.5 mm. A reflective film is bonded on the arc-shaped surface, and the reflective film is used to reflect the light emitted by a backlight source, so as to improve the utilization rate of the light.

For example, in one example, the middle frame 104 is an aluminum extruded profile. The aluminum extruded profile has a relatively flat surface, so that the above-mentioned optical adhesive can be applied flatly. It should be understood that, in other exemplary embodiments, the middle frame may also be a plastic frame.

For example, FIG. 6B is a schematic diagram of a three-dimensional structure of another display module provided by at least one embodiment of the present disclosure, and the figure on the left in FIG. 6B is a schematic diagram of an enlarged structural of the ellipse dotted region in the figure on the right in FIG. 6B. As shown in FIG. 6B, the relevant descriptions of the display module 10 can refer to the above-mentioned relevant descriptions of FIG. 6A, which are omitted herein.

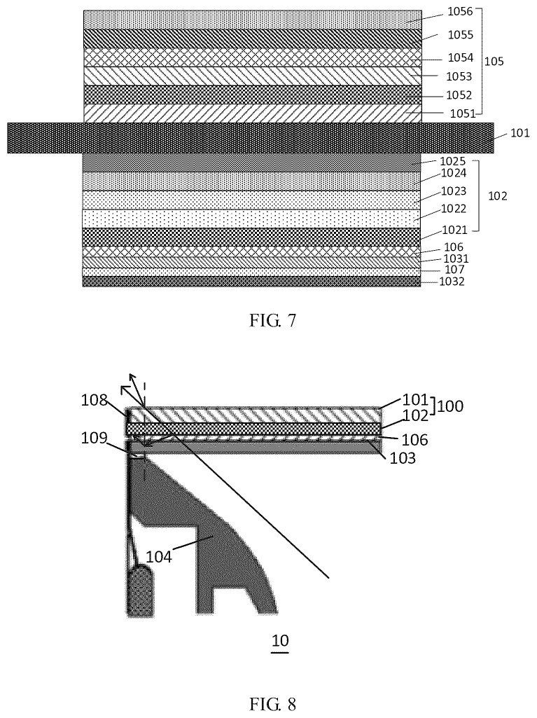

For example, FIG. 7 is a schematic diagram of a cross-sectional structure of providing a functional layer on a side of a first polarizer away from a liquid crystal cell provided by at least one embodiment of the present disclosure. As shown in FIG. 7, the first brightness enhancement layer 1031 and the first haze adjustment layer 1032 included in the functional layer 103 are stacked on the side of the first polarizer 102 away from the liquid crystal cell 101, and the first brightness enhancement layer 1031 and the first haze adjustment layer 1032 are bonded to the side of the first polarizer 102 away from the liquid crystal cell 101 by the second bonding adhesive 106.

For example, the first brightness enhancement layer 1031 is fully bonded to the first polarizer 102 by the second bonding adhesive 106, and the first haze adjustment layer 1032 is fully bonded to the first brightness enhancement layer 1031 by a first bonding adhesive 107. Both the second bonding adhesive 106 and the first bonding adhesive 107 are pressure-sensitive adhesives, hot-melt adhesives, or UV-curable adhesives.

For example, the fully bonded refers to surface lamination, and the first brightness enhancement layer 1031 is fully bonded to the first polarizer 102 by the second bonding adhesive 106 means that the bonding area between the first brightness enhancement layer 1031 and the first polarizer 102 is at least more than 80% of the area of the first brightness enhancement layer 1031 and more than 80% of the area of the first polarizer 102. The first haze adjustment layer 1032 is fully bonded to the first brightness enhancement layer 1031 by the first bonding adhesive 107 means that the bonding area between the first haze adjustment layer 1032 and the first brightness enhancement layer 1031 is at least more than 80% of the area of the first haze adjustment layer 1032 and more than 80% of the area of the first brightness enhancement layer 1031.

For example, the display module 10 further includes a second polarizer 105 provided on a side of the display panel 100 away from the first polarizer 102, the haze of the second polarizer 105 is 5%, and the haze of the first polarizer 102 is 0. The haze of the first bonding adhesive 107 is from 60% to 90%, for example, the haze of the first bonding adhesive 107 is 60%, 65%, 70%, 75%, 80%, 85% or 90%.

For example, as shown in FIG. 7, the distance between the side edge of the functional layer 103 and an edge of a side, which is the same side as the side edge of the functional layer, of the display region of the display panel is from 0.1 mm to 0.3 mm, for example, the distance is 0.1 mm, 0.2 mm, or 0.3 mm.

For example, as shown in FIG. 2A and FIG. 6A, a light-shielding tape 108 is provided on a side surface of the display panel 100. The light-shielding tape 108 is configured to fix the display panel so that the display panel 100 can maintain a stable state. For example, the light-shielding tape 108 is a UV-curable adhesive, a hot-melt adhesive, a combination of the UV-curable adhesive and the hot-melt adhesive, or a double-sided adhesive, which is not limited in the embodiments of the present disclosure, as long as the display panel 100 is fixed.

For example, the material of the light-shielding tape 108 is a polycondensate material of black terephthalic acid and ethylene glycol, and the main function of the light-shielding tape 108 is to shield the edges of the display panel and the light leaked from the backlight module to avoid the backlight module from leaking light, and at the same time to play an aesthetic role as an external surface.

For example, as shown in FIG. 2A and FIG. 6A, the display panel 100 and the middle frame 104 are connected with each other by a third bonding adhesive 109, and the third bonding adhesive 109 is a pressure-sensitive adhesive, a hot-melt adhesive, or a UV-curable adhesive.

For example, the display panel 100 and the middle frame 104 are bonded by the third bonding adhesive 109 in a form of a frame bonding, and the form of the frame bonding means that the third bonding adhesive 109 is bonded around the display panel 100 and around the middle frame 104.

For example, FIG. 8 is an optical path diagram of a display module provided by at least one embodiment of the present disclosure. As shown in FIG. 8, the light incident from the backlight source enters the display panel 100 and is reflected to the functional layer 103, and then reflected from the functional layer 103 to the first polarizer 102, that is, the light incident from the backlight source is fully utilized.

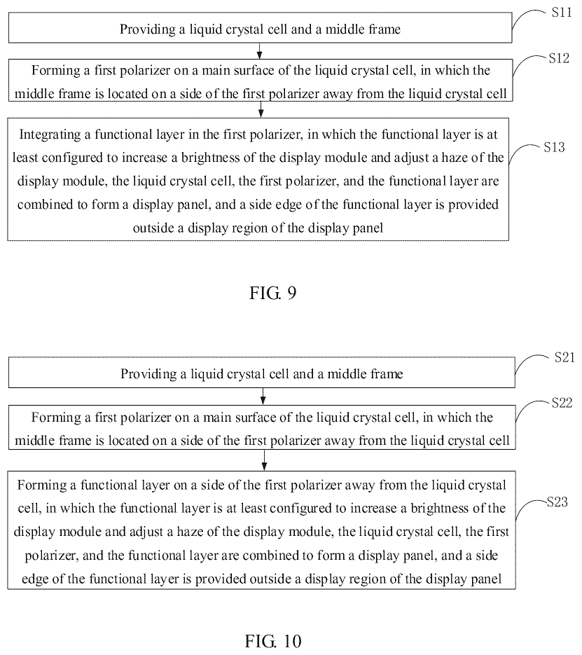

At least one embodiment of the present disclosure further provides a manufacturing method of a display module. For example, FIG. 9 is a flowchart of a manufacturing method of a display module provided by at least one embodiment of the present disclosure. As shown in FIG. 9, the manufacturing method includes the following steps.
Step S11: providing a liquid crystal cell and a middle frame:

For example, the structures of the liquid crystal cell and the middle frame may refer to the above-mentioned relevant descriptions, which are omitted herein.
Step S12: forming a first polarizer on a main surface of the liquid crystal cell, in which the middle frame is located on a side of the first polarizer away from the liquid crystal cell;
Step S13: integrating a functional layer in the first polarizer, in which the functional layer is at least configured to increase a brightness of the display module and adjust a haze of the display module, the liquid crystal cell, the first polarizer, and the functional layer are combined to form a display panel, and a side edge of the functional layer is provided outside a display region of the display panel.

For example, in one example, the functional layer includes a first brightness enhancement layer and a first haze adjustment layer which are stacked, and integrating the functional layer in the first polarizer includes: integrating the first brightness enhancement layer and the first haze adjustment layer in the first polarizer sequentially. The functional layer is at least configured to increase the brightness of the display module and adjust the haze of the display module, and the liquid crystal cell, the first polarizer and the functional layer are combined to form a display panel. The middle frame is provided on a side of the functional layer away from the liquid crystal cell, and the side edge of the functional layer is provided outside the display region of the display panel. The display module can reduce or eliminate the problem of bright edges of the surrounding films, and after removing a separately provided diffuser plate, can further reduce or eliminate the problem of dark frames at the edges of the display module caused by the expansion space reserved between the diffuser plate and the middle frame, thereby improving the picture quality and market competitiveness of the product.

For example, in one example, the display panel and the middle frame are connected with each other by a third bonding adhesive, and the assembly process of the display module is to directly bond the display panel and the middle frame by the third bonding adhesive, and the assembly process of the display module is simple and easy to operate.

For example, by using the manufacturing method in FIG. 9, the functional layer can be directly integrated into the first polarizer, so that the display module becomes thinner and lighter, and the assembly process of the backlight module is simplified.

At least one embodiment of the present disclosure further provides another manufacturing method of a display module. For example, FIG. 10 is a flowchart of another manufacturing method of a display module provided by at least one embodiment of the present disclosure. As shown in FIG. 10, the manufacturing method includes the following steps.
Step S21: providing a liquid crystal cell and a middle frame;
Step S22: forming a first polarizer on a main surface of the liquid crystal cell, in which the middle frame is located on a side of the first polarizer away from the liquid crystal cell;
Step S23: forming a functional layer on a side of the first polarizer away from the liquid crystal cell, in which the functional layer is at least configured to increase a brightness of the display module and adjust a haze of the display module, the liquid crystal cell, the first polarizer, and the functional layer are combined to form a display panel, and a side edge of the functional layer is provided outside a display region of the display panel.

For example, the functional layer includes a first brightness enhancement layer and a first haze adjustment layer which are stacked, and forming the functional layer on the side of the first polarizer away from the liquid crystal cell includes: fully bonding the first brightness enhancement layer on the first polarizer by using a first bonding adhesive, and fully bonding the first haze adjustment layer on the first brightness enhancement layer by using a second bonding adhesive.

For example, the first brightness enhancement layer is fully bonded to the first polarizer by the first bonding adhesive means that the bonding area between the first brightness enhancement layer and the first polarizer is at least more than 80% of the area of the first brightness enhancement layer and more than 80% of the area of the first polarizer. The first haze adjustment layer is fully bonded to the first brightness enhancement layer by the second bonding adhesive means that the bonding area between the first haze adjustment layer and the first brightness enhancement layer is at least more than 80% of the area of the first haze adjustment layer and more than 80% of the area of the first brightness enhancement layer.

For example, the first brightness enhancement layer and the first haze adjustment layer included in the functional layer are stacked on the side of the first polarizer away from the liquid crystal cell, and the first brightness enhancement layer and the first haze adjustment layer are bonded on the side of the first polarizer away from the liquid crystal cell by the second bonding adhesive.

For example, the first brightness enhancement layer is fully bonded to the first polarizer by the second bonding adhesive, the first haze adjustment layer is fully bonded to the first brightness enhancement layer by the first bonding adhesive, and each of the second bonding adhesive and the first bonding adhesive is a pressure-sensitive adhesive, a hot-melt adhesive, or a UV-curable adhesive.

For example, by using the manufacturing method shown in FIG. 10, the functional layer is directly bonded to a polarizer by a bonding adhesive, which enables the selection of the type and the thickness of the functional layer more flexible, and simplifies the assembly process of the backlight module, and removing the glass diffuser plate enables the display module thinner and lighter and saves material costs.

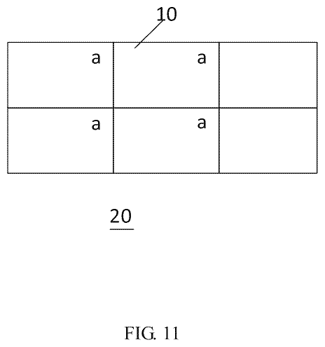

At least one embodiment of the present disclosure further provides a display device. For example, FIG. 11 is a schematic diagram of a plane structure of a display device provided by at least one embodiment of the present disclosure. As shown in FIG. 11, the display device 20 includes a splicing screen formed by a plurality of display modules 11 provided by any one of the above-mentioned embodiments. For example, although it is shown in FIG. 11 that the display device 20 includes a splicing screen formed by splicing six display modules 10, the embodiments of the present disclosure are not limited thereto. The display device may also include more display modules 10, for example, 2, 4, 9, and the like. A plurality of display modules 10 are spliced with each other, and a splicing seam is formed between any two adjacent display modules 10. In some examples, the display module 10 is a liquid crystal display module, an organic light-emitting diode (OLED) display module, or an electrophoretic display module.

For example, the display device 10 includes any one of the above-mentioned display modules, and the display device in the embodiment of the present disclosure may be any product or component with the display function, such as a display, an electronic paper, a mobile phone, a tablet computer, a notebook computer, a digital photo frame, a navigator, and so on.

The display device provided by the embodiment of the present disclosure has the same technical features and working principles as the above-mentioned display module, which will not be repeated in the embodiment of the present disclosure.

For example, in the display device provided by at least one embodiment of the present disclosure, two adjacent display modules are spliced together by the light-shielding tape included in each of the display modules 10. Referring to FIG. 8, the light-shielding tape 108 seals the display module as a whole to prevent light leakage.

At least one embodiment of the present disclosure provides a display module and a manufacturing method thereof, and a display device, which have at least one of the following beneficial technical effects.
(1) The display module provided by at least one embodiment of the present disclosure can reduce or eliminate the problem of bright edges of the surrounding film material, and after removing the separately provided diffuser plate, can further reduce or eliminate the problem of dark frames at the edges of the display module caused by the expansion space reserved between the diffuser plate and the middle frame, thereby improving the picture quality and market competitiveness of the product.
(2) In the display module provided by at least one embodiment of the present disclosure, the functional layer is directly integrated into the first polarizer, so that the display module becomes thinner and lighter, and the display panel and the middle frame are directly bonded and spliced by the third bonding adhesive, so as to simplify the assembly process of the backlight module.
(3) In the display module provided by at least one embodiment of the present disclosure, the functional layer is directly bonded to the polarizer by a bonding adhesive, which enables the selection of the type and the thickness of the functional layer more flexible, and simplifies the assembly process of the backlight module, and removing the glass diffuser plate enables the display module thinner and lighter and saves material costs.

The following statements should be noted:
(1) The accompanying drawings involve only the structure(s) in connection with the embodiment(s) of the present disclosure, and other structure(s) can be referred to common design(s).
(2) For the sake of clarity, in the accompanying drawings used to describe the embodiments of the present disclosure, the thickness of the layer or region is enlarged or reduced, i.e., these accompanying drawings are not drawn to the actual scale.
(3) In case of no conflict, features in one embodiment or in different embodiments can be combined to obtain new embodiments.

What have been described above are only specific implementations of the present disclosure, the protection scope of the present disclosure is not limited thereto, and the protection scope of the present disclosure should be based on the protection scope of the claims.

1. A display module, comprising:
a display panel, comprising a liquid crystal cell, a first polarizer, and a functional layer, wherein the first polarizer is provided on a main surface of the liquid crystal cell, and the functional layer is at least configured to increase a brightness of the display module and adjust a haze of the display module; and
a middle frame, provided on a side of the functional layer away from the liquid crystal cell, wherein
the functional layer is integrated in the first polarizer or provided on a side of the first polarizer away from the liquid crystal cell, and a side edge of the functional layer is provided outside a display region of the display panel.

2. The display module according to claim 1, wherein the functional layer comprises a first brightness enhancement layer and a first haze adjustment layer which are stacked, the first brightness enhancement layer is configured to increase the brightness of the display module, and the first haze adjustment layer is configured to adjust the haze of the display module.

3. The display module according to claim 2, wherein both of a side edge of the first brightness enhancement layer and a side edge of the first haze adjustment layer are provided outside the display region of the display panel.

4. The display module according to claim 2, wherein the first brightness enhancement layer is provided on a side of the first haze adjustment layer close to the liquid crystal cell.

5. The display module according to claim 2, wherein a haze of the first haze adjustment layer is from 70% to 90%.

6. The display module according to claim 2, wherein a material of the first haze adjustment layer comprises polyethylene terephthalate, a surface of the first haze adjustment layer comprises diffusion particles, and a particle size of each of the diffusion particles is from 1 μm to 25 μm.

7. The display module according to claim 2, wherein in a direction from the first polarizer to the liquid crystal cell, the first brightness enhancement layer comprises a brightness enhancement film, a diffusion film, and a prism layer that are stacked sequentially.

8. The display module according to claim 2, wherein the first brightness enhancement layer and the first haze adjustment layer are integrated in the first polarizer, and in a direction from the first polarizer to the liquid crystal cell, the first polarizer comprises the first haze adjustment layer, the first brightness enhancement layer, a first pressure-sensitive adhesive, a first protective layer, a first polarization functional layer, a second protective layer, and a second pressure-sensitive adhesive that are stacked sequentially.

9. The display module according to claim 8, further comprising a second polarizer provided on a side of the liquid crystal cell away from the first polarizer, and in the direction from the first polarizer to the liquid crystal cell, the second polarizer comprises a third pressure-sensitive adhesive, a third protective layer, a second polarization functional layer, a fourth protective layer, a second haze adjustment layer, and a protective film that are stacked sequentially.

10. The display module according to claim 9, wherein a haze of the second haze adjustment layer is from 50% to 90%.

11. The display module according to claim 10, wherein the haze of the second haze adjustment layer is smaller than a haze of the first haze adjustment layer.

12. The display module according to claim 2, wherein the first brightness enhancement layer and the first haze adjustment layer are stacked and provided on the side of the first polarizer away from the liquid crystal cell.

13. The display module according to claim 12, wherein the first brightness enhancement layer is fully bonded to the first polarizer by a first bonding adhesive, and the first haze adjustment layer is fully bonded to the first brightness enhancement layer by a second bonding adhesive.

14. The display module according to claim 13, further comprising a second polarizer provided on a side of the display panel away from the first polarizer, wherein a haze of the second polarizer is 5%, a haze of the first polarizer is 0, and a haze of the first bonding adhesive is from 60% to 90%.

15. The display module according to claim 13, wherein both the first bonding adhesive and the second bonding adhesive comprise a hot melt adhesive or a UV-curable adhesive.

16. The display module according to claim 1, wherein a distance between the side edge of the functional layer and an edge of a side, which is the same side as the side edge of the functional layer, of the display region of the display panel is from 0.1 mm to 0.3 mm.

17. The display module according to claim 1, wherein a light-shielding tape is provided on a side surface of the display panel.

18. The display module according to claim 17, wherein the display panel and the middle frame are connected with each other by a third bonding adhesive.

19. A manufacturing method of a display module, comprising:
providing a liquid crystal cell and a middle frame;
forming a first polarizer on a main surface of the liquid crystal cell, wherein the middle frame is located on a side of the first polarizer away from the liquid crystal cell; and
integrating a functional layer in the first polarizer or forming the functional layer on a side of the first polarizer away from the liquid crystal cell, wherein
the functional layer is at least configured to increase a brightness of the display module and adjust a haze of the display module, the liquid crystal cell, the first polarizer, and the functional layer are combined to form a display panel, and a side edge of the functional layer is provided outside a display region of the display panel.

20. (canceled)

21. (canceled)

22. (canceled)

23. A display device, comprising a splicing screen formed by splicing a plurality of display modules according to claim 1.
